(19) United States
(12) Patent Application Publication
(10) Pub. No.: US 2016/0224410 A1
(43) Pub. Date: Aug. 4, 2016

(54) PROCESSING APPARATUS, MEMORY-CONTROLLING APPARATUS, AND CONTROL METHOD OF PROCESSING APPARATUS

(71) Applicant: FUJITSU LIMITED, Kawasaki-shi (JP)

(72) Inventor: Takeo NAKAMURA, Kawasaki (JP)

(73) Assignee: FUJITSU LIMITED, Kawasaki-shi (JP)

(21) Appl. No.: 14/995,253

(22) Filed: Jan. 14, 2016

(30) Foreign Application Priority Data
Feb. 2, 2015 (JP) 2015-018578

(51) Int. Cl. G06F 11/10; G06F 3/06

(52) U.S. Cl. CPC G06F 11/1004; G06F 3/0619; G06F 3/064; G06F 3/0673

(57) ABSTRACT

In a processing apparatus according to an embodiment of the present invention, a central processing unit (CPU) outputs data, and a dual inline memory module (DIMM) includes a plurality of dynamic random access memories (DRAMs). Check bit generators generate error-checking codes for checking pieces of data output by the CPU, respectively. The check bit generators then add the generated error-checking codes to respective pieces of the data, thereby generating pieces or data with respective error-checking codes. A data-to-be-written selecting circuit splits each piece of the data with the respective error-checking codes generated by the cheek bit generators and stores a piece of the split data with the respective error-checking codes in a portion of corresponding one of the DRAMs.

### CROSS-REFERENCE TO RELATED APPLICATION

This application is based upon and claims the benefit of priority of the prior Japanese Patent Application No. 2015-018578, filed on Feb. 2, 2015, the entire contents of which are incorporated herein by reference.

### FIELD

The embodiments discussed herein are related to a processing apparatus, a memory-controlling apparatus, and a control method of the processing apparatus.

### BACKGROUND

Processing apparatuses including a memory such as a dynamic random access memory (DRAM) and preferably having performance of high reliability as a system often include a memory with an error-checking and correction (ECC) function (hereinafter, referred to as “ECC memory”).

During writing data in such an ECC memory, an ECC check bit is generated and written in the memory together with the data at the same time. During reading data in an ECC memory, an ECC check bit is read and used for error-checking and correction of the data.

For example, in a memory system, two pieces of dual inline memory module (DIMM) with ECC each including 18 pieces of 4-bit DRAMs are coupled to a memory controller, and simultaneously accessed. In this example, two cycles of the data, that is, 288 bits of data is defined as a unit for error-checking and correction (ECC) by a single check bit (hereinafter referred to as an ECC unit). The data is divided into 264 bits of data and 24 bits of ECC check bit data by using single 8-bit error correction-double 8-bit error detection (S8EC-D8ED) for the ECC unit. In the memory system, failure in all of the 4 bits in a DRAM for all cycles can be corrected and simultaneous failures in two of the DRAMs can also be detected.

The following describes the operation of the memory system. In the memory system, for writing data, a data-to-be-written receiver receives data-to-be-written in the memory from a central processing unit (CPU) or an input/output (I/O) controller, for example. In the memory system, check bits are generated from the received data and added to the data. Subsequently, the data with the check bits is written in a DIMM through a memory interface unit.

When reading data, the memory system reads data from the DIMM through the memory interface unit. Subsequently, the memory system corrects the data and sends the data to the CPU or the I/O controller, for example.

Correction of 4 bits of error occurring in a DRAM can be achieved by allocating 8-bit units, in which error-checking and correction is possible, to each of the 36 pieces of the DRAMs in two coupled DIMMs. This operation achieves checking 4 bits of error occurring in each of the two DRAMs. Hereinafter, the 8-bit unit in which the error-checking and correction is possible is referred to as a block.

Frequently occurring errors in a DRAM are often 1-bit failures. That is, simultaneous failures in two DRAMs are often 1-bit failures in each of the DRAMs. If a block is allocated to each of 4-bit DRAMs, the 1-bit failures occurring in each of the two DRAMs are not able to be corrected. Sometimes 1-bit errors occurring in three or more DRAMs are not able to be checked.

A conventional technology in Japanese Laid-open Patent Publication No. 2009-245218 has been developed that increases the number of ECC check bits to correct 1-bit failures in a plurality of DRAMs.

Unfortunately, with the conventional technology, increasing the number of ECC check bits decreases the amount of data to be written because a large number of check bits are allocated.

According to an aspect of an embodiment, a processing apparatus includes: processor that outputs data; a storage that includes a plurality of storage areas for storing data output by the processor; a data generator that generates an error-checking code for checking data output by the processor and adds the generated error-checking code to the data to generate data with the error-checking code; and a storage controller that splits the data with the error-checking code generated by the data generator and stores a piece of the split data with the error-checking code in a portion of corresponding one of the storage areas.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a processing apparatus according to an embodiment of the present invention;

FIG. 2 is a block diagram of a memory controller according to a first embodiment of the present invention;

FIG. 3 is a diagram of an example of the storage state of data in a DIMM according to the first embodiment;

FIG. 4 is a flowchart of a writing process of the data to be written in the DIMM by the memory controller according to the first embodiment;

FIG. 5 is a flowchart of a reading process of the data to be read from the DIMM by the memory controller according to the first embodiment;

FIG. 6 is a diagram of an example of the storage state of data in the DIMM according to a modification of the first embodiment;

FIG. 7 is a block diagram a memory controller according to a second embodiment of the present invention;

FIG. 8 is a flowchart of a reading process of the data to be read from a DIMM by the memory controller according to the second embodiment;

FIG. 9 is a block diagram of a memory controller according to a third embodiment of the present invention;

FIG. 10 is a diagram of an example of the storage state of data in a DIMM according to the third embodiment; and

FIG. 11 is a block diagram of a memory controller according to a fourth embodiment of the present invention.

### DESCRIPTION OF EMBODIMENTS

Preferred embodiments of the present invention will be explained with reference to accompanying drawings. The embodiments of the processing apparatus, the memory-controlling apparatus, and the control method of the processing apparatus disclosed herein are not intended to limit the scope of the invention.

### [a] First Embodiment

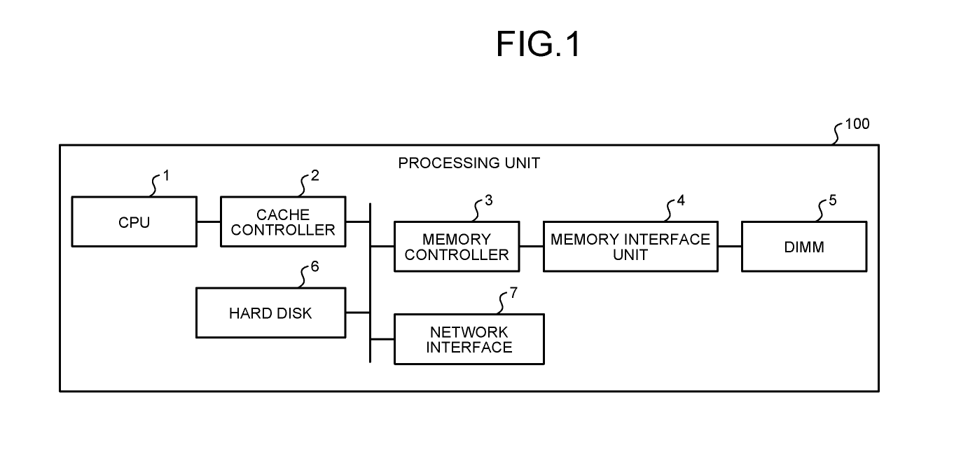

FIG. 1 is a block diagram of a processing apparatus according to an embodiment. A processing apparatus 100 includes a central processing unit (CPU) 1, a cache controller 2, a memory controller 3, a memory interface unit 4, a dual inline memory module (DIMM) 5, a hard disk 6, and a network interface 7.

The CPU 1 is an example of a processor. The CPU 1 acquires data from the DIMM 5, the hard disk 6, or the network interface 7. The CPU 1 then performs processing by using the data that has been input. Subsequently, the CPU 1 outputs the result of processing. The CPU 1 inputs and outputs the data through the cache controller 2.

The DIMM 5 is a main storage device and an example of a storage. The DIMM 5 includes a plurality of pieces of dynamic random access memory (DRAM). In the present embodiment, the DIMM 5 includes 36 pieces of 4-bit DRAM 51. That is, the DIMM 5 sends and receives 144 bits of data per cycle. In the present embodiment, the memory controller 3 handles two cycles of the data, that is, 288 bits of data as a unit for error-checking and correction (ECC), that is, an ECC unit. The actual data is 264 bits out of the data in units of ECC stored in the DIMM 5 and the remaining 24 bits are the ECC check bits. This configuration enables the DIMM 5 to perform error-checking and correction of the data in units of 8 bits. The DRAM 51 is an example of a storage area.

The memory interface unit 4 is an interface and intermediates the communication and data exchange between the memory controller 3 and the DIMM 5.

The memory controller 3 is a memory-controlling apparatus. The memory controller 3 controls the DIMM 5 to read and write the data. Specifically, the memory controller 3 receives data from the CPU 1 or other data-input/output device including the hard disk 6 and the network interface 7. The memory controller 3 then generates 24 bits of check bits by using the received 264 bits of data. Through the memory interface unit 4, the memory controller 3 controls the DIMM 5 to store therein the data obtained by adding the generated 24 bits of check bits to the received 264 bits of data. In the present embodiment, the memory controller 3 performs eight cycles of burst transfer of date.

The memory controller 3 receives a data-reading instruction from the CPU 1, for example, and reads the data from the DIMM 5. The memory controller 3 than determines whether any error occurs in the read data by using the check bits of the read data. If no error occurs, the memory controller 3 outputs the read data. If any error occurs, the memory controller 3 corrects the error if the error occurring is correctable and outputs the corrected data. If the error occurring is difficult to correct, the memory controller 3 outputs a notice of occurrence of the error.

The hard disk 6 is an auxiliary storage device. The hard disk 6 stores data in response to an instruction from the CPU 1. The hard disk 6 reads data in response to an instruction from the CPU 1 and outputs the data.

The network interface 7 is a communication interface for communicating with an external device such as other processing apparatus, for example. The CPU 1 and the memory controller 3 send and receive data to and from the external device through the network interface 7.

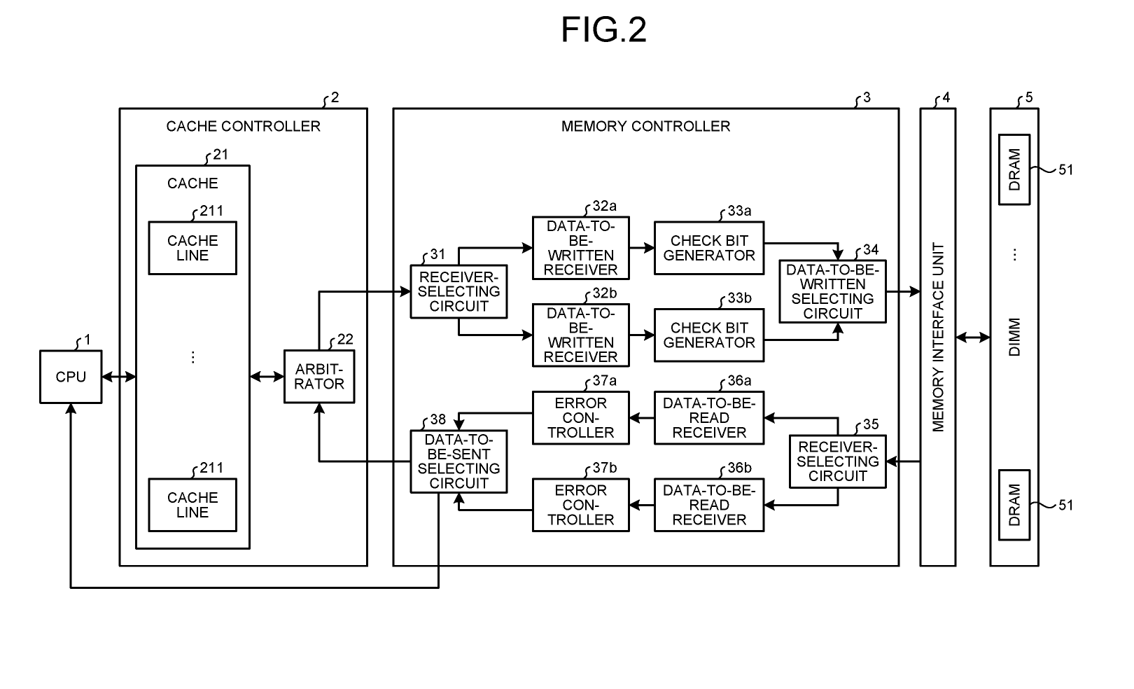

The following describes in detail writing and reading of data to and from the DIMM 5 by the memory controller 3 according to the present embodiment with reference to FIG. 2. FIG. 2 is a block diagram of the memory controller according to the first embodiment. The following describes an example of writing of data sent from the CPU 1, and an example of reading of data by the CPU 1.

The cache controller 2 includes a cache 21 and an arbitrator 22. The cache 21 includes a plurality of cache lines 211.

The data to be written that has been input by the CPU 1 is temporarily stored in any of the cache lines 211. The arbitrator 22 determines from which of the cache lines 211 it will acquire the data to be written. The arbitrator 22 then acquires the data to be written from the determined cache line 211 and outputs the acquired data to a receiver-selecting circuit 31 in the memory controller 3.

The arbitrator 22 also acquires the data to be read from a data-to-be-sent selecting circuit 38 in the memory controller 3. The arbitrator 22 then determines in which of the cache lines 211 it will store the data to be read. Subsequently, the arbitrator 22 writes the data to be read on the determined cache line 211.

The following describes an example of writing of data. The receiver-selecting circuit 31 receives the data to be written from the arbitrator 22. Subsequently, the receiver-selecting circuit 31 determines whether data has been stored in a data-to-be-written receiver 32a. The fact that data has been stored in the data-to-be-written receiver 32a represents that 264 bits of data has been stored in the data-to-be-written receiver 32a.

If the data has not been stored in the data-to-be-written receiver 32a, the receiver-selecting circuit 31 outputs 264 bits of the received data to be written to the data-to-be-written receiver 32a. If the data has been stored in the data-to-be-written receiver 32a, the receiver-selecting circuit 31 outputs 264 bits of the received data to be written to a data-to-be-written receiver 32b.

The data-to-be-written receiver 32a accumulates the data until it completes receiving 264 bits of the data to be written from the receiver-selecting circuit 31. The data-to-be-written receiver 32a stands by for the data-to-be-written receiver 32b to start receiving 264 bits of the data to be written. After the data-to-be-written receiver 32b completes receiving 264 bits of the data to be written, the data-to-be-written receiver 32a outputs 264 bits of the data to written it holds to a check bit generator 33a.

The data-to-be-written receiver 32b stands by until it completes receiving 264 bits of the data to be written from the receiver-selecting circuit 31. After the data-to-be-written receiver 32b completes receiving 264 bits of the data to be written, the data-to-be-written receiver 32b outputs 264 bits of the data to be written it holds to a check bit generator 33b.

The check bit generator 33a receives the input of 264 bits of the data to be written from the data-to-be-written receiver 32a. Subsequently, the check bit generator 33a generates a 24-bit error-correcting code from the received 264 bits of the data to be written. This error-correcting code is an example of an error-checking code for error-checking and correction (ECC).

Subsequently, the check bit generator 33a adds the generated 24-bit error-correcting code to the received 264 bits of the data to be written, thereby generating 288 bits of the data to be written. The 288 bits of the data to be written generated by the check bit generator 33a is data with an error-correcting code (data with ECC) and is the data in units of ECC. This data with the error-correcting code (the data with ECC) is an example of data with an error-checking code. Hereinafter, the pieces of data in units of ECC that have been written by a data-to-be-written selecting circuit 34 at once are collectively called a group.

The check bit generator 33a receives the input of 264 bits of the data to be written from the data-to-be-written receiver 32b. Subsequently, the check bit generator 33b generates a 24-bit error-correcting code from the received 264 bits of the data to be written. Subsequently, the check bit generator 33b adds the generated 24-bit error-correcting code to the received 264 bits of the data to be written, thereby generating 288 bits of the data to be written. These check bit generators 33a and 33b are examples of a data generator.

The data-to-be-written selecting circuit 34 stands by for the check bit generators 33a and 33b to accumulate therein four cycles of the data to be written in total, that is, 288 bits of the data, respectively.

The data-to-be-written selecting circuit 34 then sequentially selects the check bit generator 33a or the check bit generator 33b as the source of data to be written. In the description here, the data-to-be-written selecting circuit 34 selects the check bit generator 33a as a first source of data to be written, and then selects the check bit generator 33b as a second source of data to be written.

The data-to-be-written selecting circuit 34 acquires 72 bits of the data to be written from the check bit generator 33a firstly selected. The data-to-be-written selecting circuit 34 then acquires 72 bits of the data to be written from the check bit generator 33b secondly selected. The data-to-be-written selecting circuit 34 writes the acquired total 144 bits of the data to be written on the DIMM 5 through the memory interface unit 4. Specifically, the data-to-be-written selecting circuit 34 writes the data to be written received from the check bit generator 33a on the 0th and 1st bits in each of the DRAMs 51. The data-to-be-written selecting circuit 34 also writes the data to be written received from the check bit generator 33b on the 2nd and 3rd bits in each of the DRAMs 51. This writing of 144 bits of the data to be written is one cycle of writing.

The data-to-be-written selecting circuit 34 repeats the above-described writing process of the data to be written on the DIMM 5 until the respective 288 bits of the data held by the check bit generators 33a and 33b have been transferred. That is, the data-to-be-written selecting circuit 34 performs four cycles of the writing process because it writes 144 bits of the data on the DIMM 5 per cycle. The data-to-be-written selecting circuit 34 is an example of a storage controller.

The four cycles of the writing process performed by the data-to-be-written selecting circuit 34 stores an 8-bit block in the 0 and 1 bits in each of the DRAMs 51. The 8-bit block is a unit for error-checking and correction in a given group. In the 2 and 3 bits in each of the DRAMs 51, another 8-bit block is stored that is a unit for error-checking and correction of data in a group different from the group of data stored in the 0 and 1 bits in each of the DRAMs 51. In this manner, one of the DRAMs 51 stores blocks in two different groups. That is, blocks generated by dividing data in a group are stored in portions of each of the DRAMs 51, respectively. The 0 and 1 bits in the DRAMs 51 are examples of an upper split storage area. The 2 and 3 bits in the DRAMs 51 are examples of a lower split storage area. When a plurality of groups exist, the general name of the blocks in each of the groups (blocks in two groups, in the present embodiment) is an example of split data.

When using an ECC function, if one of the DRAMs 51 has any error, 2 bits of error per group can be corrected. Accordingly, with the data storage state in the present embodiment, 4 bits of error in one of the DRAMs 51 can be corrected. If two of the DRAMs 51 fail and if the groups of the data stored in the respective fault bits are different, up to 2 bits of failure can be corrected. The 2 bits of failure in up to four of the DRAMs 51 can be detected.

Description is continued with reference to FIG. 2 again. The receiver-selecting circuit 31, the data-to-be-written receivers 32a and 32b, the check bit generators 33a and 33b, and the data-to-be-written selecting circuit 34 repeat the above-described storing process of the data to be written on the DIMM 5 until storing of eight bursts of the data to be written is completed. Specifically, repeating the above-described storing process of the data to be written on the DIMM 5 once again completes storing of eight bursts of the data to be written. As a result, the memory controller 3 completes one data transfer process. If the data to be written still exists, the memory controller 3 repeats the data transfer process until writing of all pieces of the data to be written is completed.

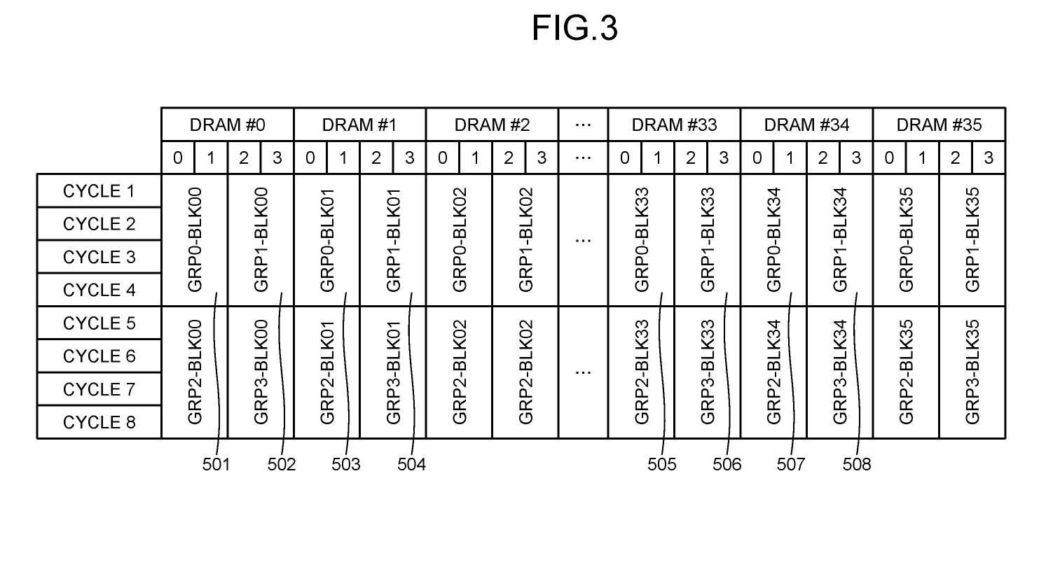

The following describes in detail the data storage state in the DIMM 5 provided by the memory controller 3 according to the present embodiment with reference to FIG. 3. FIG. 3 is a diagram of an example of the storage state of data in the DIMM according to the first embodiment.

In FIG. 3, the 36 pieces of the DRAM 51 are represented with the DRAM #0 to DRAM #35, respectively. A group of data is represented with a code including “GRP” plus a number; and a block (a unit in which error-checking and correction is possible) of data is represented with a code including “BLK” plus a number. For example, GRP0-BLK00 represents the data in a 00th block in a 00th group.

As illustrated in FIG. 3, in the 0th and 1st bits in each of the DRAMs #0 to #35, pieces of the data in the group GRP0 are stored as the data for the first to fourth cycles. In the 0th and 1st bits in the DRAMs #0 to #35, different blocks are allocated. In the 2nd and 3rd bits in each of the DRAMs #0 to #35, pieces of the data in the group GRP1 that is different from the group of data in the 0th and 1st bits are stored. In the 2nd and 3rd bits in the DRAMs #0 to #35, different blocks are allocated.

In the 0th and 1st bits in each of the DRAMs #0 to #35, pieces of the data in the group GRP2 are stored as the data in the fifth to eighth cycles. In the 2nd and 3rd bits in each of the DRAMs #0 to #35, the pieces of data in the group GRP3 are stored as the data for the fifth to eighth cycles.

The following describes a reading process of the data to be read. A receiver-selecting circuit 35 acquires the data to be read from the DRAMs 51 in the DIMM 5 through the memory interface unit 4. Specifically, the receiver-selecting circuit 35 acquires 4 bits of the data to be read from each of the DRAMs 51 per cycle, and 144 bits of the data to read in total per cycle. The receiver-selecting circuit 35 then determines whether all pieces of the data-to-be-read read from the 0th and 1st bits in each of the DRAMs 51 out of 144 bits of the data have been stored in a data-to-be-read receiver 36a.

If any piece of the data to be read that is to be stored in the data-to-be-read receiver 36a is left, the receiver-selecting circuit 35 outputs the data read from the 0th and 1st bits in each of the DRAMs 51 to the data-to-be-read receiver 36a.

If the data to be read is completely stored in the data-to-be-read receiver 36a, the receiver-selecting circuit 35 outputs the data read from the 2nd and 3rd bits in each of the DRAMs 51 to a data-to-be-read receiver 36b. After the storing of the data to be read to the data-to-be-read receiver 36b has been completed, the receiver-selecting circuit 35 performs a second cycle of reading process of the data to be read.

The receiver-selecting circuit 35 repeats reading and outputting the data until it outputs eight cycles of the data.

The data-to-be-read receiver 36a receives the input of the data to be read from the receiver-selecting circuit 35. The data-to-be-read receiver 36a stands by until all of 288 bits of the data to be read in a group are stored. After the storing of the 288 bits of the data to be read in the group has been completed, the data-to-be-read receiver 36a outputs pieces of the data to be read in the group that have been completely stored, to an error controller 37a.

The data-to-be-read receiver 36b receives the input of the data to be read from the receiver-selecting circuit 35. The data-to-be-read receiver 36b stands by until all of 288 bits of the data to be read in a group are stored. After the storing of the 288 bits of the data to be read in the group has been completed, the data-to-be-read receiver 36b outputs pieces of the data to be read in the group that have been completely stored, to an error controller 37b.

The error controller 37a receives the input of 288 bits of the data to be read in a group from the data-to-be-read receiver 36a. The error controller 37a acquires a 24-bit error-correcting code from the check bits of the received data to be read. The error controller 37a then performs error-checking of the remaining 264 bits of the data to be read by using the acquired error-correcting code. For pieces of data that belong to a group, the error controller 37a can correct errors of 2 bits or less in one of the DRAMs 51 and check errors of 2 bits or less in two respective DRAMs 51.

If no error is detected, the error controller 37a outputs the received data to be read to the data-to-be-sent selecting circuit 38.

By contrast, if any error (failure) of 2 bits or less in one of the DRAMs 51 is detected, the error controller 37a corrects the errors in the data to be read. The error controller 37a then outputs the corrected data to be read to the data-to-be-sent selecting circuit 38.

If any error (failure) of 2 bits or less in two respective DRAMs 51 are detected, the error controller 37a notifies the data-to-be-sent selecting circuit 38 of the detected error.

The error controller 37b receives the input of 288 bits of the data to be read in a group from the data-to-be-read receiver 36b. The error controller 37b acquires a 24-bit error-correcting code from the check bits of the received data to be read. The error controller 37b then performs error-checking of the remaining 264 bits of the data to be read by using the acquired error-correcting code. The error controller 37b checks failures of 2 bits or less in one of the DRAMs 51 and failures of 2 bits or less in two respective DRAMs 51.

If no error is detected, the error controller 37b outputs the received data to be read to the data-to-be-sent selecting circuit 38.

By contrast, if any error (failure) of 2 bits or less in one of the DRAMs 51 is detected, the error controller 37b corrects the errors in the data to be read. The error controller 37b then outputs the corrected data to be read to the data-to-be-sent selecting circuit 38.

If errors (failures) of 2 bits or less in two respective DRAMs 51 are detected, the error controller 37b notifies the data-to-be-sent selecting circuit 38 of the detected error.

The error controller 37a and the error controller 37b independently perform error-checking of the data in different bits in different groups in one of the DRAMs 51. That is, the bits detected by the error controller 37a and the bits detected by 38b are different from each other. Accordingly, the results of the error-checking and correction performed by the error controllers 37a and 38b are not overlapped. This operation enables the error controllers 37a and 38b to achieve the error-checking and correction as described below.

The following describes in greater detail the error-checking and correction performed by the memory controller 3 according to the present embodiment with reference to FIG. 3.

In the example below, an error occurs in the 0th bit in the DRAM #0. The pieces of the data stored in the 0th bit in the DRAM #0 belong to GRP0-BLK00, as represented with a section 501. On this occasion, a 1-bit error occurs in a block in the group GRP0, and the error controller 37a corrects the error.

In the example below, an error occurs in the 1st bit in the DRAM #0 in addition to an error occurring in the 0th bit in the DRAM #0. The data stored in the 1st bit in the DRAM #0 belongs to GRP0-BLK00, as represented with the section 501. On this occasion, 2 bits of error occur in a block in the group GRP0, and the error controller 37a corrects the error.

In the example below, errors occur in the 2nd and 3rd bits in the DRAM #0. The pieces of the data stored in the 2nd and 3rd bits in the DRAM #0 belong to GRP1-BLK00, as represented with a section 502. That is, the pieces of the data stored in the 2nd and 3rd bits in the DRAM #0 belong to a group different from the group of data stored in the 0th and 1st bits. Accordingly, the pieces of data stored in the 2nd and 3rd bits in the DRAM #0 are also subject to the error correction by the error controller 37b independent from and in the same manner as the error correction in the 0th and 1st bits. If errors occur in all of 0th to 3rd bits in the DRAM #0, therefore, the error controllers 37a and 37b correct the errors.

In the example below, errors occur in the 0th and 1st bits in the DRAM #0, and the 2nd and 3rd bits in the DRAM #1. The pieces of the data stored in the 2nd and 3rd bits in the DRAM #1 belong to GRP1-BLK01, as represented with a section 504. That is, in the 2nd and 3rd bits in the DRAM #1, the same error correction process is performed as that on the 2nd and 3rd bits in the DRAM #0. Accordingly, the error controller 37a corrects any error of 2 bits or less in a block in the group GRP0. The error controller 37b also corrects any error of 2 bits or less in a block in the group GRP1. This operation enables the memory controller 3 to correct errors of 2 bits or less in the 0th and 1st bits in the DRAM #0 and errors of 2 bits or less in the 2nd and 3rd bits in the DRAM #1 even though these errors simultaneously occur.

By contrast, in the example below, errors occur in the 0th and 1st in the DRAM #1 in addition to errors occurring in the 0th and 1st in the DRAM #0. The pieces of the data stored in the 0th and 1st bits in the DRAM #1 belong to GRP0-BLK01, as represented with a section 503. That is, the data stored in the 0th and 1st bits in the DRAM #0 and the data stored in the 0th and 1st bits in the DRAM #1 belong to the group GRP0 and to different blocks. In other words, errors occur in two different blocks in an identical group. Accordingly, the error controller 37a can check the errors but is not able to correct them.

The error controllers 37a and 37b independently perform error-checking. This operation achieves parallel checking of errors in any bit storing the pieces of the data that belong to the group GRP0 in two of the DRAMs 51 and of errors in any bit storing the pieces of the data that belong to the group GRP1 in two of the DRAMs 51. For example, the pieces of the data stored in the 2nd and 3rd bits in the DRAMs #33 and #34 belong to the group GRP1, as represented with sections 506 and 508. This operation enables the memory controller 3 to check errors in the 0th and 1st bits in the DRAMs #0 and #1, and errors in the 2nd and 3rd bits in the DRAMs #33 and #34 even though these errors occur simultaneously.

By contrast, the pieces of the data stored in the 0th and 1st bits in the DRAMs #33 and #34 belong to the group GRP0, as represented with sections 505 and 507. If errors occur in the 0th and 1st bits in the DRAMs #33 and #34 while errors occur in the 0th and 1st bits in the DRAMs #0 and #1, therefore, errors occur in three or more blocks in an identical group. Accordingly, the error controller 37a is not able to check the errors.

As described above, the memory controller 3 according to the present embodiment corrects 4 bits of error in one of the DRAMs 51. If the groups of the data stored in the fault bits are different in two of the DRAMs 51, the memory controller 3 corrects the error of 2 bits or less in each of them. If the groups of the data stored in the fault bits are identical, the memory controller 3 only checks errors. The memory controller 3 also checks 4 bits of failure in two respective DRAMs 51. Unless three or more groups including the data stored in the fault bits are overlapped, errors of 2 bits or less in up to four DRAMs 51 are checked.

When the data-to-be-sent selecting circuit 38 receives the data from the error controller 37a or 37b, the data-to-be-sent selecting circuit 38 sends the received data to the arbitrator 22. If the data-to-be-sent selecting circuit 38 receives a notice of occurrence of error from the error controller 37a or 37b, the data-to-be-sent selecting circuit 38 notifies the CPU 1 of the occurrence of the error.

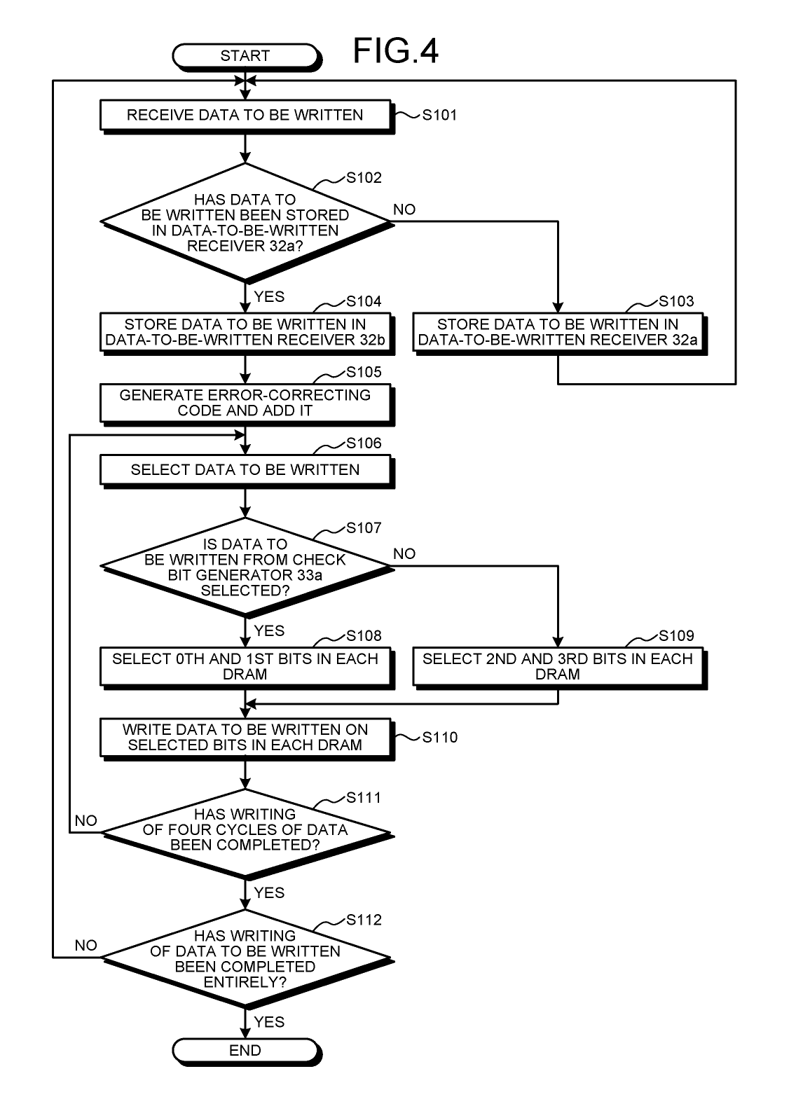

The following describes the flow of a writing process on the data to be written in the DIMM 5 by the memory controller 3 according to the present embodiment with reference to FIG. 4. FIG. 4 is a flowchart of the writing process of the data to be written in the DIMM by the memory controller according to the first embodiment.

The receiver-selecting circuit 31 receives the data to be written from the arbitrator 22 (Step S101).

The receiver-selecting circuit 31 determines whether the data to be written has been stored in the data-to-be-written receiver 32a (Step S102). If the data to be written has not been stored in the data-to-be-written receiver 32a (No at Step S102), the receiver-selecting circuit 31 stores the received data to be written in the data-to-be-written receiver 32a (Step S103). Subsequently, the receiver-selecting circuit 31 returns the process to Step S101.

If the data to be written has been stored in the data-to-be-written receiver 32a (Yes at Step S102), the receiver-selecting circuit 31 stores the received data to be written in the data-to-be-written receiver 32b (Step S104). After the storing of the data has been completed, the data-to-be-written receivers 32a and 32b output the data to be written to the check bit generators 33a and 33b, respectively.

The check bit generators 33a and 33b generate error-correcting codes from the received data to be written, and add the generated error-correcting codes to the data to be written, respectively (Step S105).

The data-to-be-written selecting circuit 34 selects the data to be written in the DIMM 5 out of the data to be written held by the check bit generators 33a and 32b (Step S106).

The data-to-be-written selecting circuit 34 then determines whether it selects the data to be written from the check bit generator 33a (Step S107). If the data-to-be-written selecting circuit 34 selects the data to be written from the check bit generator 33a (Yes at Step S107), the data-to-be-written selecting circuit 34 selects the 0th and 1st bits in each of the DRAMs 51 as the destination for the writing (Step S108).

If the data-to-be-written selecting circuit 34 selects the data to be written from the check bit generator 33b (No at Step S107), the data-to-be-written selecting circuit 34 selects the 2nd and 3rd bits in each of the DRAMs 51 as the destination for the writing (Step S109).

The data-to-be-written selecting circuit 34 then writes the data to be written on the selected bits in each of the DRAMs 51 (Step S110).

The data-to-be-written selecting circuit 34 determines whether it has completed writing four cycles of the data (Step S111). If the data-to-be-written selecting circuit 34 has not completed writing four cycles of the data (No at Step S111), the data-to-be-written selecting circuit 34 returns the process to Step S106.

If the data-to-be-written selecting circuit 34 has completed writing four cycles of the data (Yes at Step S111), the receiver-selecting circuit 31 determines whether writing of the data to be written has been completed entirely (Step S112). That is, the receiver-selecting circuit 31 determines whether writing of eight cycles of the data to be written has been completed. If the data to be written is remaining (No at Step S112), the receiver-selecting circuit 31 returns the process to Step S101.

If the writing of the data to be written has been completed entirely (Yes at Step S112), all of the receiver-selecting circuit 31 to the data-to-be-written selecting circuit 34 end the writing process. The flowchart in FIG. 4 illustrates the writing process of burst transfer for one time. To write all pieces of the specified data to be written on the DIMM 5, the memory controller 3 repeats the process illustrated in the flow in FIG. 4 until the data to be written has been transferred.

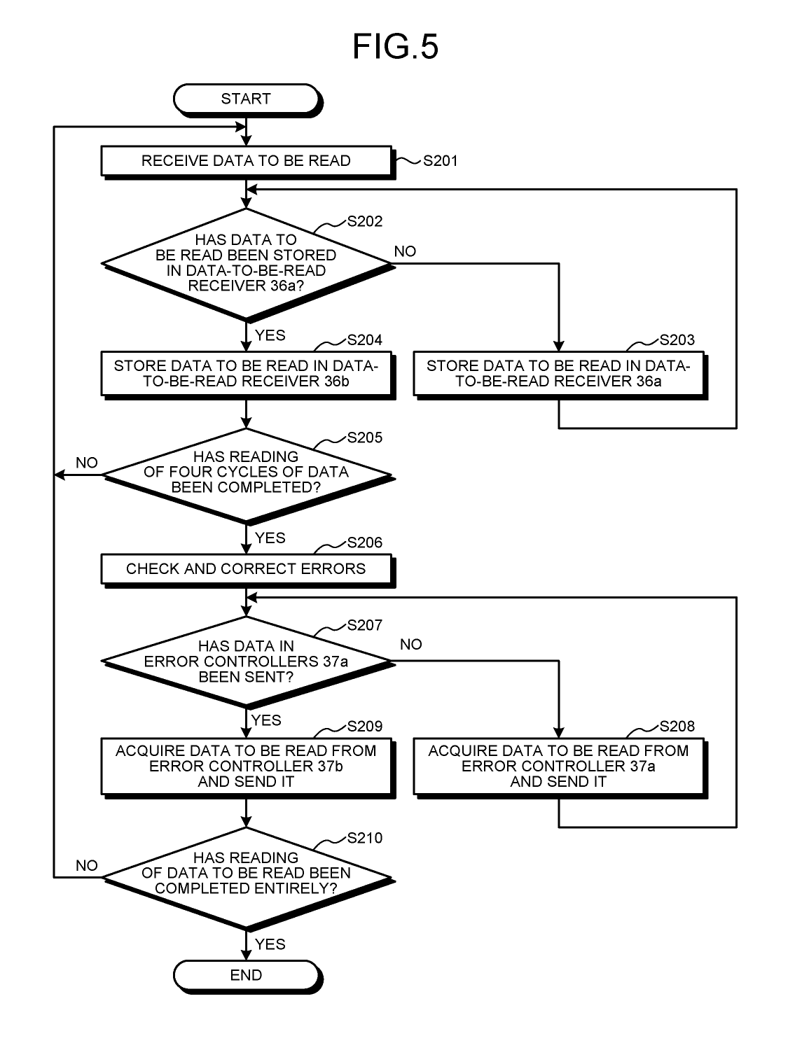

The following describes the flow of a reading process on the data to be read from the DIMM 5 by the memory controller 3 according to the present embodiment with reference to FIG. 5. FIG. 5 is a flowchart of the reading process of the data to be read from the DIMM by the memory controller according to the first embodiment.

The receiver-selecting circuit 35 receives one cycle of the data to be read from the DRAMs 51 in the DIMM 5 (Step S201).

Subsequently, the receiver-selecting circuit 35 determines whether the data has been stored in the data-to-be-read receiver 36a, that is, all pieces of the data to be read that had been stored in the 0th and 1st bits in the DRAMs 51 have been stored in the data-to-be-read receiver 36a (Step S202). If some pieces of the data to be read have not yet been stored in the data-to-be-read receiver 36a (No at Step S202), the receiver-selecting circuit 35 stores pieces of the data to be read that had been stored in the 0th and 1st bits in the DRAMs 51 in the data-to-be-read receiver 36a (Step S203). The receiver-selecting circuit 35 then returns the process to Step S202.

If the data to be read has already been stored in the data-to-be-read receiver 36a (Yes at Step S202), the receiver-selecting circuit 35 stores the data to be read that had been stored in the 2nd and 3rd bits in the DRAMs 51 in the data-to-be-read receiver 36b (Step S204).

The receiver-selecting circuit 35 determines whether the data-to-be-read receivers 36a and 36b each have completed storing of four cycles of the data to be read (Step S205). In the description here, pieces of the data in two groups are read in four cycles. If the storing of four cycles of the data to be read has not yet been completed (No at Step S205), the receiver-selecting circuit 35 returns the process to Step S201.

If the storing of four cycles of the data to be read has been completed (Yes at Step S205), the data-to-be-read receivers 36a and 36b output the data to be read to the error controllers 37a and 37b, respectively. The error controllers 37a and 37b receive the input of the data to be read from the data-to-be-read receivers 36a and 36b, respectively. The error controllers 37a and 37b then perform error-checking and correction by using the error-correcting code added to the received data to be read (Step S206).

The data-to-be-sent selecting circuit 38 determines whether the data in the error controller 37a has been sent (Step S207). If the data in the error controller 37a has not yet been sent (No at Step S207), the data-to-be-sent selecting circuit 38 acquires the data to be read from the error controller 37a and sends the acquired data to be read to the arbitrator 22 (Step S208). Subsequently, the data-to-be-sent selecting circuit 38 returns the process to Step S207.

If the data in the error controller 37a has already been sent (Yes at Step S207), the data-to-be-sent selecting circuit 38 acquires the data to be read from the error controller 37b and sends the acquired data to be read to the arbitrator 22 (Step S209).

Subsequently, the receiver-selecting circuit 35 determines whether reading of all pieces of the data to be read has been completed, that is, whether the reading of eight cycles of the data has been completed (Step S210). If some pieces of the data to be read are remaining (No at Step S210), the receiver-selecting circuit 35 returns the process to Step S201.

If the reading of the data to be read has been completed entirely (Yes at Step S210), the receiver-selecting circuit 35 to the data-to-be-sent selecting circuit 38 end the reading process.

As described above, the memory controller according to the present embodiment stores pieces of data that belong to different ECC units in different bits in a DRAM. This operation achieves error correction if failures of 2 bits or less occur in two of the DRAMs. This operation also achieves error-checking if failures of 2 bits or less occur in four DRAMs.

In the memory controller according to the present embodiment, the number (size) of bits of the check bit is not increased for expanding the range of detection. Therefore, the present embodiment according to the present invention provides the processing apparatus, the memory-controlling apparatus, and the control method of the processing apparatus with expanded range of checking and correction of data without decreasing the amount of data to be written.

Modification

The following describes a modification of the first embodiment. In the first embodiment, pieces of the data that belong to an identical group are stored in the 0th and 1st bits in each of the DRAMs 51; and pieces of the data that belong to another identical group are stored in the 2nd and 3rd bits therein. The storage positions of the data are not limited to the ones described above, and pieces of the data may be stored in other positions as long as pieces of the data that belong to an identical group are stored in two bits in one of the DRAMs 51.

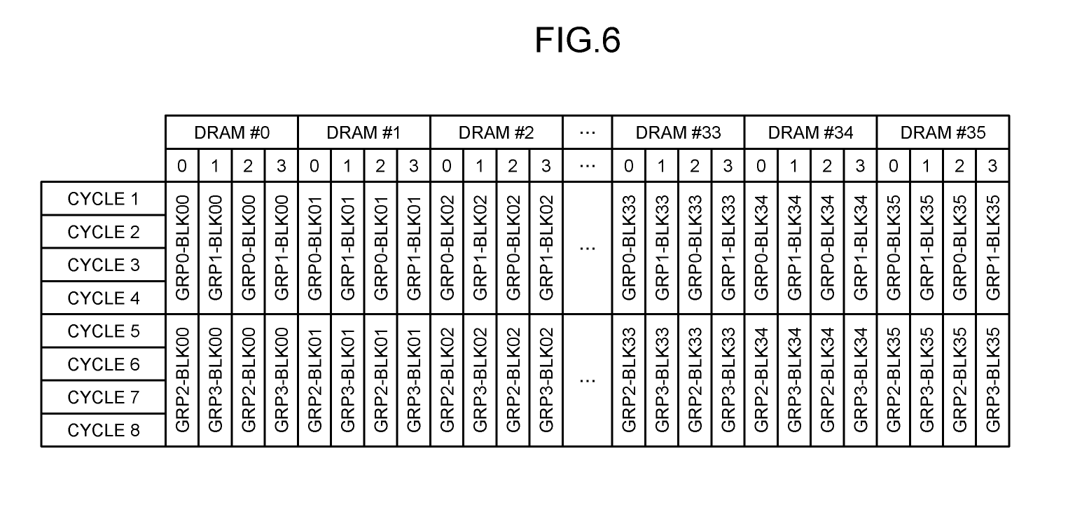

As illustrated in FIG. 6, the memory controller 3 according to the present modification, for example, stores pieces of the data that belong to an identical group in the 0th and 1st bits in each of the DRAMs 51 and pieces of the data that belong to another identical group in the 2nd and 3rd bits therein. FIG. 6 is a diagram of an example of the storage state of data in a DIMM according to a modification of the first embodiment.

Also in the storage state of data illustrated in FIG. 6, pieces of data that belong to two groups are stored in one of the DRAMs 51. That is, the pieces of data stored in the 0th and 2nd bits are subject to error-checking and correction by the ECC function in the group GRP0; and the pieces of data stored in the 1st and 3rd bits are subject to error-checking and correction by the ECC function in the group GRP1.

Therefore, as illustrated in FIG. 6, storing pieces of data that belong to an identical group in two bits in a DRAM achieves error correction in the same manner as the first embodiment if failures of 2 bits or less occur in two of the DRAMs. This operation also achieves error-checking if failures of 2 bits or less occur in four DRAMs.

In the first embodiment and the modification, the pieces of data that belong to an identical group are stored in the same bit positions in all of the DRAMs 51. The description is provided merely for exemplary purpose and not limiting. For another example, pieces of data that belong to an identical group may be stored in different bit positions as described below. In the DRAM #0 in FIG. 6, the 0th and 1st bits may each store the pieces of the data that belong to the group GRP0; and the 2nd and 3rd bits may each store the pieces of the data that belong to the group GRP1. In the DRAM #1 in FIG. 6, the 0th and 1st bits may each store pieces of the data that belong to the group GRP0; and the 2nd and 3rd bits may each store pieces of the data that belong to the group GRP1. In this manner, even if the pieces of the data that belong to an identical group are stored in different bit positions depending on the DRAMs, the error-checking and correction can also be achieved.

### [b] Second Embodiment

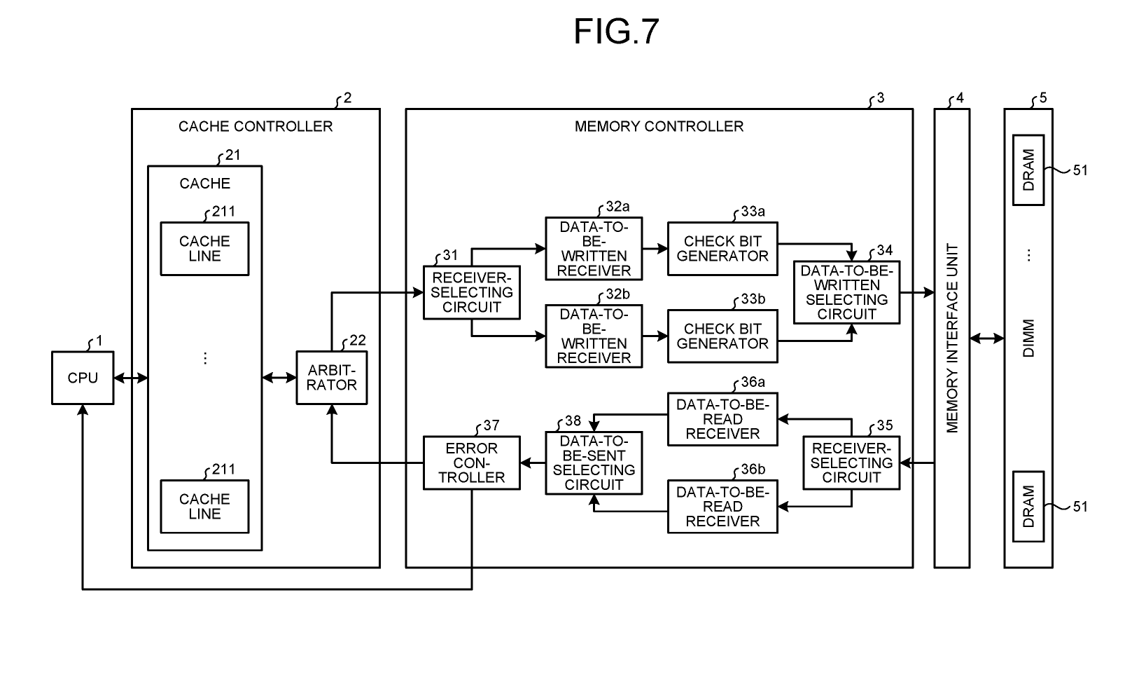

FIG. 7 is a block diagram of a memory controller according to a second embodiment. The memory controller according to the present embodiment differs from that in the first embodiment in respect of including a single integrated error controller 37. In the description below, explanations are omitted for operations of the components similar to those in the first embodiment.

The memory controller 3 according to the present embodiment allocates the 264 bits of the data for the two cycles in the first half of the data to be written to the group GRP0 or the group GRP2; and allocates the 264 bits of the data for the two cycles in the latter half of the data to be written to the group GRP1 or the group GRP3. The unit for sending and receiving data between the cache controller 2 and the memory controller 3 is 264 bits or less per cycle.

Under these conditions, as illustrated in FIG. 7, the single error-controller 37 can control error-checking and correction of pieces of data.

The data-to-be-read receivers 36a and 36b receive the input of 72 bits of data per cycle from the receiver-selecting circuit 35. The data-to-be-read receivers 36a and 36b hold the data to be read until they accumulate 288 bits of the data.

After the data-to-be-read receivers 36a and 36b have accumulated 288 bits of the data to be read, the data-to-be-sent selecting circuit 38 determines whether sending of the data in the data-to-be-read receiver 36a has been completed. If the sending of the data in the data-to-be-read receiver 36a has not yet completed, the data-to-be-sent selecting circuit 38 acquires the data from the data-to-be-read receiver 36a and sends the data to the error controller 37.

If the sending of the data in the data-to-be-read receiver 36a has already been completed, the data-to-be-sent selecting circuit 38 acquires the data from the data-to-be-read receiver 36b and outputs the data to the error controller 37.

The error controller 37 receives the input of the data to be read from the data-to-be-sent selecting circuit 38. The error controller 37 then performs error-checking and correction by using the error-correcting code of the received data to be read. If no error or correctable error exists, the error controllers 37 outputs the data to the arbitrator 22. If an error difficult to be correct is detected, the error controller 37 notifies the CPU 1 of occurrence of the error.

As described above, when the data exchange unit between the error controller 37 and the arbitrator 22 is 264 bits, the error controller 37 can receive 288 bits of the data to be read for every transmission, perform error-checking and correction, and send the data. In this manner, the error-checking and correction can also be achieved on the pieces of the data that belong to groups through a single error-controller 37.

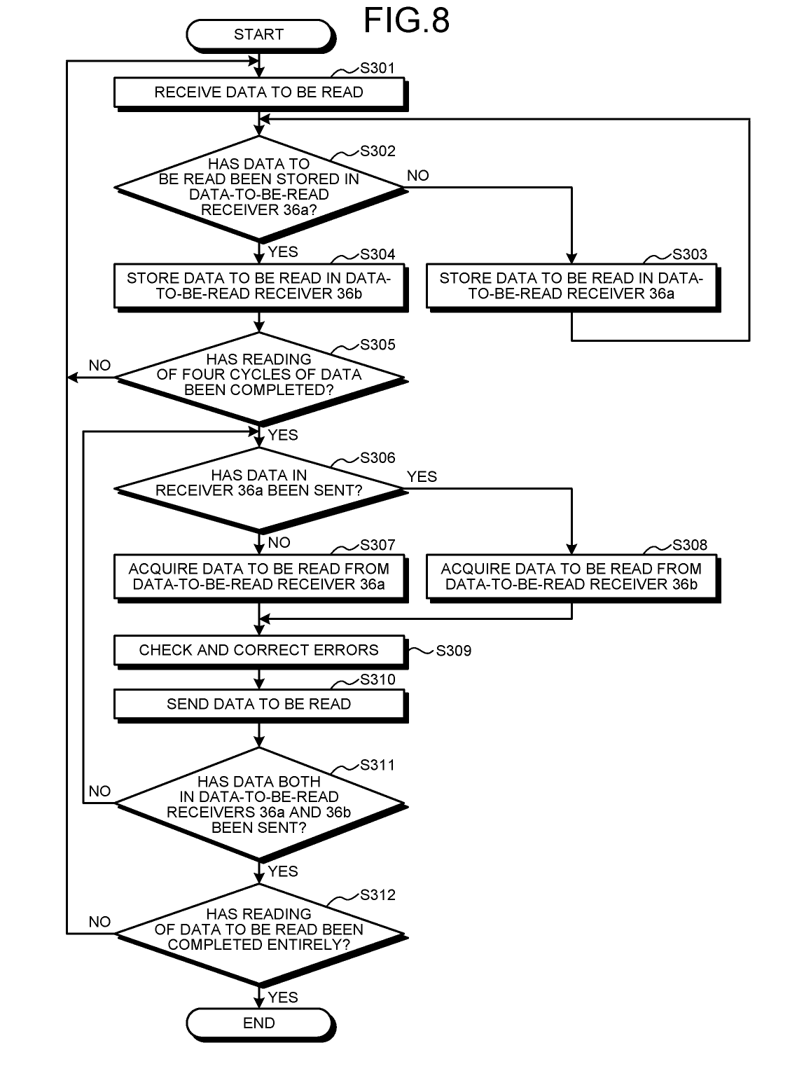

The following describes the flow of a reading process on the data to be read from the DIMM 5 by the memory controller 3 according to the present embodiment with reference to FIG. 8. FIG. 8 is a flowchart of the reading process of the data to be read from the DIMM by the memory controller according to the second embodiment.

The receiver-selecting circuit 35 receives the data to be read from the DRAMs 51 in the DIMM 5 (Step S301).

Subsequently, the receiver-selecting circuit 35 determines whether the data to be read has been stored in the data-to-be-read receiver 36a, that is, all pieces of data to be read that had been stored in the 0th and 1st bits in the DRAMs 51 have been stored in the data-to-be-read receiver 36a (Step S302). If the data has not been stored in the data-to-be-read receiver 36a (No at Step S302), the receiver-selecting circuit 35 stores the acquired data to be read in the data-to-be-read receiver 36a (Step S303). The receiver-selecting circuit 35 then returns the process to Step S302.

If the data to be read has already been stored in the data-to-be-read receiver 36a (Yes at Step S302), the receiver-selecting circuit 35 stores the data to be read that had been stored in the 2nd and 3rd bits in the DRAMs 51 in the data-to-be-read receiver 36b (Step S304).

The receiver-selecting circuit 35 determines whether the data-to-be-read receivers 36a and 36b each have completed storing of four cycles of the data to be read (Step S305). In the description here, pieces of the data in two groups are read in four cycles. If the storing of four cycles of the data to be read has not yet completed (No at Step S305), the receiver-selecting circuit 35 returns the process to Step S301.

If the storing of four cycles of the data to be read has already been completed (Yes at Step S305), the data-to-be-sent selecting circuit 38 determines whether sending of the data from the data-to-be-read receiver 36a has been completed (Step S306). If the data has not been sent from the data-to-be-read receiver 36a (No at Step S306), the data-to-be-sent selecting circuit 38 acquires the data to be read from the data-to-be-read receiver 36a (Step S307). The data-to-be-sent selecting circuit 38 then outputs the acquired data to be read to the error controller 37.

If the data has already been seat from the data-to-be-read receiver 36a (Yes at Step S306), the data-to-be-sent selecting circuit 38 acquires the data to be read from the data-to-be-read receiver 36b (Step S308). The data-to-be-sent selecting circuit 38 then outputs the acquired data to be read to the error controller 37.

The error controller 37 receives the input of the data to be read from the data-to-be-sent selecting circuit 38. The error controller 37 then performs error-checking and correction by using the error-correcting code added to the received data to be read (Step S309).

The error controller 37 sends the data that has been subject to the error-checking and correction to the arbitrator 22 (Step S310).

Subsequently, the data-to-be-sent selecting circuit 38 determines whether the pieces of data in both the data-to-be-read receivers 36a and 36b have been sent (Step S311). If the data to be sent is remaining (No at Step S311), the data-to-be-sent selecting circuit 38 returns the process to Step S306.

If the pieces of data in both the data-to-be-read receivers 36a and 36b have been sent (Yes at Step S311), the receiver selecting circuit 35 determines whether the reading of all pieces of data to be read has been completed, that is, the reading of eight cycles of the data has been completed (Step S312). If the data to be read is remaining (No at Step S312), the receiver-selecting circuit 35 returns the process to Step S301.

If the reading of the data to be read has been completed entirely (Yes at Step S312), all of the receiver-selecting circuit 35 to the data-to-be-sent selecting circuit 38 end the reading process.

As described above, the memory controller according to the present embodiment achieves error-checking and correction of all pieces of data to be read through a single error-controller. Therefore, the number of pieces of error controllers having a large circuit can be reduced, whereby the increase of the size of the circuit is prevented.

### [c] Third Embodiment

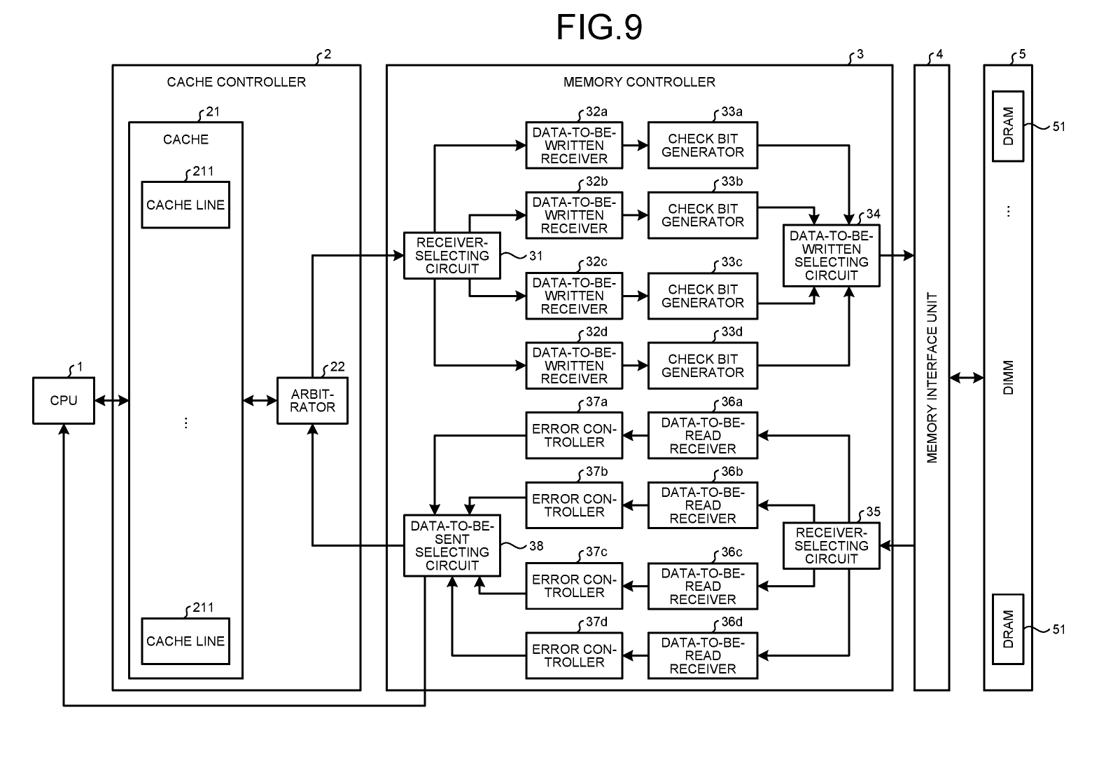

FIG. 9 is a block diagram of a memory controller according to a third embodiment. The memory controller according to the present embodiment differs from that in the first embodiment in respect of storing pieces of data that belong to different groups in four different bits in a DRAM. In the description below, explanations are omitted for operations of the components similar to those in the first embodiment.

The memory controller 3 according to the present embodiment includes the data-to-be-written receivers 32a to 32d, the check bit generators 33a to 33d, the data-to-be-read receivers 36a to 36d, and the error controllers 37a to 37d.

The receiver-selecting circuit 31 stores 264 bits of the data to be written out of the data to be written received from the arbitrator 22, in each of the data-to-be-written receivers 32a to 32d.

After the data-to-be-written receivers 32a to 32d each complete the storing of data to be written, the data-to-be-written receivers 32a to 32d output the data to be written to the check bit generators 33a to 33d, respectively.

The check bit generators 33a to 33d receive the input of the data to be read from the data-to-be-written receivers 32a to 32d, respectively. Subsequently, the check bit generators 33a to 33d each generate a 24-bit error-correcting code and generate 288 bits of the data to be written by adding generated error-correcting code.

After the check bit generators 33a to 33d complete the adding of the error-correcting codes, the data-to-be-written selecting circuit 34 acquires 36 bits of the data to be written from the respective check bit generators 33a to 33d.

The data-to-be-written selecting circuit 34 then stores pieces of the data to be written acquired from the check bit generator 33a in the 0th bit in each of the DRAMs 51. The data-to-be-written selecting circuit 34 also stores the pieces of the data to be written acquired from the check bit generator 33b in the 1st bit in each of the DRAMs 51. In addition, the data-to-be-written selecting circuit 34 stores the pieces of the data to be written acquired from the check bit generator 33c in the 2nd bit in each of the DRAMs 51. Furthermore, the data-to-be-written selecting circuit 34 stores the pieces of the data to be written acquired from the check bit generator 33d in the 3rd bit in each of the DRAMs 51. The data-to-be-written selecting circuit 34 stores those pieces of the data to be written in one cycle.

The data-to-be-written selecting circuit 34 performs eight cycles of burst transfer, that is, the data-to-be-written selecting circuit 34 repeats acquiring the data to be written from the check bit generators 33a to 33d and storing the acquired date to be written eight times. This operation enables the data-to-be-written selecting circuit 34 to store 8 bits of the data to be written that belong to a group, in the bits in the DRAMs 51.

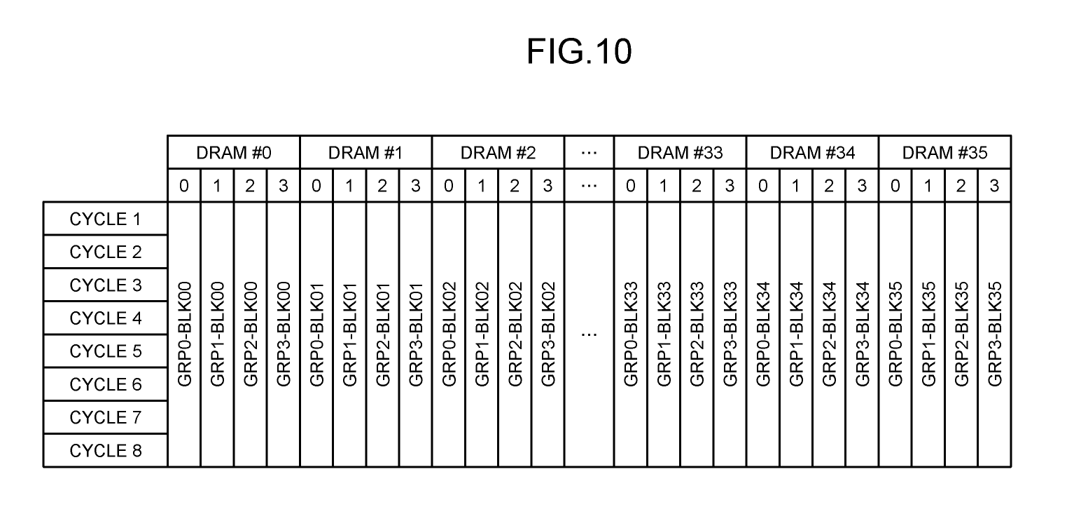

The following describes the data storage state in the DIMM 5 provided by the memory controller 3 according to the present embodiment with reference to FIG. 10. FIG. 10 is a diagram of an example of the storage state of data in the DIMM according to the third embodiment.

As illustrated in FIG. 10, pieces of 8-bit data that belong to the group GRP0 are stored in the 0th bits in the DRAMs #0 to #35. In the 0th bits in the DRAMs #0 to #35, different blocks are allocated, and pieces of data that belong to the group GRP1 are stored in the 1st bits in the DRAMs #0 to #35. In the 1st bits in the DRAMs #0 to #35, different blocks are allocated, and pieces of data that belong to the group GRP2 are stored in the 2nd bits in the DRAMs #0 to #35. In the 2nd bits in the DRAMs #0 to #35, different blocks are allocated, and pieces of data that belong to the group GRP3 are stored in the 3rd bits in the DRAMs #0 to #35. In the 3rd bits in the DRAMs #0 to #35, different blocks are allocated

The receiver-selecting circuit 35 reads 4 bits of the data to be read from each of the DRAMs 51 per cycle, and 144 bits of the data is to be read in total per cycle. The receiver-selecting circuit 35 then outputs the pieces of the data that belong to GRP0 out of the read data to be read, to the data-to-be-read receiver 36a. The receiver-selecting circuit 35 outputs the pieces of the data that belong to GRP1 out of the read data to be read, to the data-to-be-read receiver 36b. The receiver-selecting circuit 35 outputs the pieces of the data that belong to GRP2 out of the read data to be read, to a data-to-be-read receiver 36c. The receiver-selecting circuit 35 outputs the pieces of the data that belong to GRP3 out of the read data to be read, to the data-to-be-read receiver 36d. The receiver-selecting circuit 35 performs eight cycles of reading and outputting of the data to be read.

The data-to-be-read receivers 36a and 36d hold the data to be read until they accumulate 288 bits of the data. Because the ECC unit is 288 bits and completeness of all pieces of data in a group enables the subsequent error controllers 37a to 37d to perform error-checking and correction.

After the data-to-be-read receivers 36a and 36d accumulate therein 288 bits of the data, they send the data to be read to the error controllers 37a to 37d, respectively.

The error controllers 37a to 37d receive the input of 288 bits the data in the respective identical groups from the data-to-be-read receivers 36a to 36d. The error controllers 37a to 37d then perform error-checking and correction of the received data to be read.

The following describes the error-checking and correction performed by the error controllers 37a to 37d according to the present embodiment with reference to FIG. 10. The error controllers 37a to 37d each perform error-checking and correction of pieces of data belonging to different groups. That is, the error controllers 37a to 37d independently perform error-checking. Accordingly, the error controllers 37a to 37d can perform error-checking and correction on each held data to be read if the errors occur in one of the DRAMs 51. In addition, the error controllers 37a to 37d can perform error-checking on each held data to be read if the errors occur in two of the DRAMs 51.

That is, the memory controller 3 can correct errors (failures) if an error of 1 bit storing one of the pieces of the data that belong to different groups occurs in each of four DRAMs 51. Accordingly, up to 4 bits of error in one of the DRAMs 51 can be corrected.

The memory controller 3 can correct errors occurring in 1 bit storing one of the pieces of the data that belongs to an identical group in any of the DRAMs 51. For example, the memory controller 3 can correct errors occurring in 2 bits storing pieces of the data that belong to different groups in two of the DRAMs 51 and the groups of the data stored in the fault bits are different between the fault DRAMs 51.

The memory controller 3 can check errors occurring in up to 4 bits in each of two DRAMs 51.

The memory controller 3 can also check errors if failures in 1 bit storing one of the pieces of the data that belong to an identical group in a pair of two DRAMs 51 occur in four different pairs of DRAMs 51. As described above, the memory controller 3 according to the present embodiment can correct 1-bit errors in up to eight of the DRAMs 51.

In addition, the memory controller 3 can check errors if a 2-bit failure occurs in one of the DRAMs 51 and three or more groups do not overlap in four of the DRAMs 51. That is, the memory controller 3 according to the present embodiment can also check 2 bits of error occurring in each of up to four DRAMs 51.

The data-to-be-sent selecting circuit 38 selects any of the error controllers 37a to 37d and acquires the data to be read therefrom. The data-to-be-sent selecting circuit 38 then outputs the acquired data to be read to the arbitrator 22. It is noted that the data-to-be-sent selecting circuit 38 can select and send the data in any order.

As described shove, the memory controller according to the present embodiment can correct 1-bit errors in up to 4 pieces of the DRAMs. The memory controller according to the present embodiment can correct 2-bit errors in up to 4 pieces of the DRAMs. The memory controller according to the present embodiment can check 1-bit errors in up to 8 pieces of the DRAMs. As described above, the memory controller according to the present embodiment can check and correct errors in a wider range. The memory controller according to the present embodiment achieves increased stability of the system if frequent 1-bit errors occur.

### [d] Fourth Embodiment

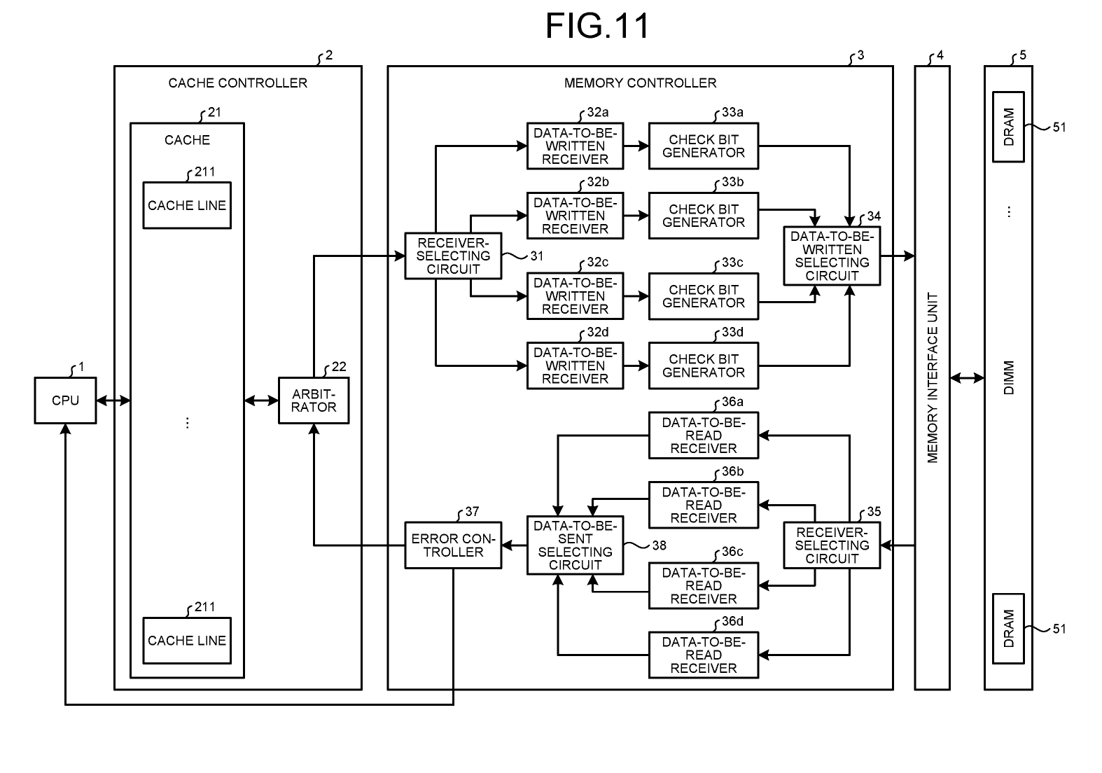

FIG. 11 is a block diagram of a memory controller according to a fourth embodiment. The memory controller according to the present embodiment differs from that in the third embodiment in respect of including a single integrated error controller. In the description below, explanations are omitted for operations of the components similar to those in the third embodiment.

In the memory controller 3 according to the present embodiment, the unit for exchanging data between the cache controller 2 and the memory controller 3 is 264 bits or less per cycle. Under the condition, as illustrated in FIG. 11, the single error-controller 37 can control error-checking and correction of pieces of data.

For example, the data-to-be-sent selecting circuit 38 acquires the data to be read from the data-to-be-read receiver 36a and outputs the data to the error controller 37. If the acquired data to be read from the data-to-be-read receiver 36a is sent from the error controller 37, the data-to-be-sent selecting circuit 38 acquires the data to be read from the data-to-be-read receiver 36b and outputs the data to the error controller 37. If the acquired data to be read from the data-to-be-read receiver 36b is sent from the error controller 37, the data-to-be-sent selecting circuit 38 acquires the data to be read from the data-to-be-read receiver 36c and outputs the data to the error controller 37. If the acquired data to be read from the data-to-be-read receiver 36c is sent from the error controller 37, the data-to-be-sent selecting circuit 38 acquires the data to be read from the data-to-be-read receiver 36d and outputs the data to the error controller 37.

The error controller 37 receives the input of the data to be read output from the data-to-be-read receiver 36a, from the data-to-be-sent selecting circuit 38. The error controller 37 then performs error-checking and correction of the data to be read output from the data-to-be-read receiver 36a. The error controller 37 sends 264 bits of the data that has been subjected to the error-checking and correction to the arbitrator 22.

The error controller 37 then receives the input of the data to be read output from the data-to-be-read receiver 36b, from the data-to-be-sent selecting circuit 38. The error controller 37 performs error-checking and correction of the data to be read output from the data-to-be-read receiver 36b. The error controller 37 sends 264 bits of the data that has been subjected to the error-checking and correction to the arbitrator 22.

The error controller 37 then receives the input of the data to be read output from the data-to-be-read receiver 36c, from the data-to-be-sent selecting circuit 38. The error controller 37 performs error-checking and correction of the data to be read output from the data-to-be-read receiver 36c. The error controller 37 sends 264 bits of the data that has been subjected to the error-checking and correction to the arbitrator 22.

The error controller 37 then receives the input of the data to be read output from the data-to-be-read receiver 36d, from the data-to-be-sent selecting circuit 38. The error controller 37 performs error-checking and correction of the data to be read output from the data-to-be-read receiver 36d. The error controller 37 sends 264 bits of the data that has been subjected to the error-checking and correction to the arbitrator 22.

In this manner, the error controller 37 completes sending eight cycles of the data to be read.

As described above, the memory controller according to the present embodiment includes the functions according to the third embodiment and achieves error-checking and correction of all pieces of data to be read through the single error-controller. Therefore, the number of pieces of the error controller can be reduced, which has a large circuit, whereby increase of the size of the circuit is prevented while achieving the error-checking and correction in a still wider range.

In the present embodiment, the eight bursts of transfer is adopted, but the description is provided merely for exemplary purpose and not limiting. For example, the data may be accumulated by performing four bursts of transfer twice to acquire eight bursts of data, and then stored in the DIMM 5 after adding error-correcting codes thereto, in the same manner as the present embodiment.

In the embodiments described above, two units of ECC, that is, groups are generated by using four cycles of data. However, the description is provided merely for exemplary purpose and not limited thereto. The data may be stored in another method as long as each block included in an ECC unit is stored in a portion of each of the DRAMs. For example, if the size of burst transfer is 144-bit and the ECC unit is 288-bit per cycle, the data of 144 bits×n (the number of cycles) is used for generating the data of 288 bits×m (the ECC unit, that is, the number of groups) (n is an integer of 3 or larger and m is an integer of 2 or larger; n>m). Subsequently, the generated m pieces of the ECC unit are split into blocks, and the pieces of the data are stored so that blocks in units of ECC are stored in the DRAMs.

According to an aspect of the processing apparatus, the memory-controlling apparatus, and the control method of the processing apparatus disclosed herein, the range of checking and correction of data can be expanded without decreasing the amount of data to be written.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A processing apparatus comprising:
a processor that outputs data;
a storage that includes a plurality of storage areas for storing data output by the processor;
a data generator that generates an error-checking code for checking data output by the processor and adds the generated error checking code to the data to generate data with the error-checking code; and
a storage controller that splits the data with the error-checking code generated by the data generator and stores a piece of the split data with the error-checking code in a portion of corresponding one of the storage areas.

2. The processing apparatus according to claim 1, wherein
the processor outputs first data and second data,
the data generator generates first data with an error-checking code from the first data and second data with an error-checking code from the second data, and
the storage controller generates first split data by splitting the first data with an error-checking code, and second split data by splitting the second data with an error-checking code; and stores a piece of the first split data in one of an upper split storage area and a lower split storage area each of which is an area obtained by splitting corresponding one of the storage areas into two areas, and a piece of the second split data in the other split storage area in the corresponding one of the storage areas.

3. The processing apparatus according to claim 1, wherein
the data generator accumulates pieces of data of amount obtained by multiplying a given amount that is able to be stored in the storage at a time, that is, the data with the error-checking code multiplied by m (m is an integer of 2 or larger), and then multiplied by n (n is an integer of 3 or larger, and n>m), and
the storage controller repeats n times a process of acquiring the given amount of data out of the pieces of data accumulated by the data generator and storing the acquired data in corresponding one of the storage areas, to store the data stored in units for error-checking in m pieces of the data with the error-checking code, in the corresponding one of the storage areas.

4. The processing apparatus according to claim 1, further comprising at least one error controller that acquires the data with the error-checking code split and stored in the storage areas, generates the data with the error-checking code, and checks errors in the generated data by using the error-checking code.

5. The processing apparatus according to claim 4, wherein
the storage controller stores split data obtained by splitting a plurality of pieces of the data with the error-checking code in the storage areas, and
the processor comprises the at least one error controller including a plurality of error controllers that each acquire the split data from corresponding one of the storage areas, to each acquire any one of the pieces of the data with the error-checking code to check errors in each piece of the data.

6. The processing apparatus according to claim 4, wherein
the storage controller stores split data obtained by splitting a plurality of pieces of the data with the error-checking code in the storage areas, and
the one error controller acquires the split data from the storage areas so that the error controller sequentially acquires the pieces of the data with the error-checking code to sequentially check errors in each piece of the data.

7. A memory-controlling apparatus coupled to a processor that outputs data, and a memory including a plurality of storage areas for storing data output by the processor, the memory-controlling apparatus comprising:
a data generator that generates an error-checking code for checking data output by the processor and adds the generated error-checking code to the data to generate data with the error-checking code; and
a storage controller that splits the data with the error-checking code generated by the data generator and stores a piece of the split data with the error-checking code in a portion of corresponding one of the storage areas.

8. A control method of a processing apparatus that comprises a processor and a storage including a plurality of storage areas for storing data, the control method comprising:
generating an error-checking code for checking data output by the processor;
adding the generated error-checking code to the data to generate data with the error-checking code;
splitting the generated data with the error-checking code; and
storing a piece of the split data with the error-checking code in a portion of corresponding one of the storage areas.
